(19) United States
(12) Patent Application Publication
(10) Pub. No.: US 2021/0219314 A1
(43) Pub. Date: Jul. 15, 2021

(54) USER APPARATUS AND BASE STATION APPARATUS

(71) Applicant: NTT DOCOMO, INC., Tokyo (JP)

(72) Inventors: Ryosuke Osawa, Chiyoda-ku, Tokyo (JP); Kazuaki Takeda, Chiyoda-ku, Tokyo (JP); Satoshi Nagata, Chiyoda-ku, Tokyo (JP); Huan Wang, Beijing, Haidian District (CN); Xufei Zheng, Beijing, Haidian District (CN); Xiaolin Hou, Beijing, Haidian District (CN)

(73) Assignee: NTT DOCOMO, INC., Tokyo (JP)

(21) Appl. No.: 15/734,005

(22) PCT Filed: Jun. 7, 2018
(86) PCT No.: PCT/JP2018/021952

§ 371 Date: Dec. 1, 2020

(51) Int. Cl. H04W 72/12; H04W 24/10; H04W 76/14

(52) U.S. Cl. CPC H04W 72/1263; H04W 76/14; H04W 24/10

(57) ABSTRACT

A user apparatus has a request unit configured to transmit a scheduling request to a base station apparatus, an acquisition unit configured to receive information indicative of a resource pool based on the scheduling request from the base station apparatus, and a communication unit configured to perform sidelink transmission to another user apparatus using the resource pool.

### TECHNICAL FIELD

The present invention relates to a user apparatus and a base station apparatus in a radio communication system.

### Back Ground Art

In LTE (Long Term Evolution) and a succeeding system of LTE (for example, LTE-A (LTE Advanced), NR (New Radio) (also referred to as 5G)), D2D (Device to Device) technology in which user apparatuses directly communicate with each other without a radio base station has been considered (for example, Non-Patent Document 1).

D2D reduces traffic between the user apparatus and the base station apparatus, and allows for communication between user apparatuses even in a case where a base station apparatus becomes incapable of communicating at a time of disaster, etc. In the meantime, although in 3GPP (3rd Generation Partnership Project) D2D is referred to as “sidelink,” a more common term D2D is used herein. However, sidelink is also used as needed in the explanation of embodiments described later.

D2D is classified into D2D discovery for locating other user apparatuses capable of communication and D2D communication for direct communication each other between user apparatuses. In the following, it is simply referred to as D2D when D2D communication, D2D discovery, etc. are not specifically distinguished. A variety of use cases of services relating to V2X (Vehicle to Everything) in 5G are being considered (for example, Non-Patent Document 2).

### Prior Art Document

### Non-Patent Document

Non-Patent Document 1: 3GPP TS 36.211 V15.1.0 (2018-03)
Non-Patent Document 2: 3GPP TR 22.886 V15.1.0 (2017-03)

### SUMMARY OF INVENTION

### Problem to Be Solved By Invention

In D2D communication in which V2X is contemplated, when a non-periodic event trigger type traffic occurred, it was difficult to provide a control for efficiently allocating a resource which a communication terminal requires.

The present invention is made in view of the above-described points and intends to efficiently allocate a resource which a communication terminal requires in a terminal to terminal direct communication.

### Means for Solving the Problem

In accordance with the disclosed technologies, there is provided a user apparatus comprising a request unit configured to transmit a scheduling request to a base station apparatus, an acquisition unit configured to receive information indicative of a resource pool based on the scheduling request from the base station apparatus, and a communication unit configured to perform sidelink transmission to the user apparatus using the resource pool.

### Advantage of Invention

In accordance with the disclosed technologies, it is possible to efficiently allocate a resource which a communication terminal requires in a terminal to terminal direct communication.

### BRIEF DESCRIPTION OF DRAWINGS

FIG. 1 is a diagram for explaining V2X.

FIG. 2 is a sequence diagram for explaining a procedure of communication control in an embodiment of the present invention.

FIG. 3 is a flow chart for explaining a procedure of communication control in an embodiment of the present invention.

FIG. 4 is a diagram showing an example of a resource pool in an embodiment of the present invention.

FIG. 5 is a diagram showing an example of a functional arrangement of a base station apparatus 10 in an embodiment of the present invention.

FIG. 6 is diagram showing an example of a functional arrangement of a user apparatus 20 in an embodiment of the present invention.

FIG. 7 is a diagram showing an example of a hardware arrangement of a base station apparatus 10 or a user apparatus 20 in an embodiment of the present invention.

### EMBODIMENTS OF INVENTION

In the following, an embodiment of the present invention is explained with reference to drawings. In the meantime, an embodiment explained below is an example, and an embodiment for which the present invention is applied is not restricted to the embodiment below.

In an operation of a radio communication system of an embodiment of the present invention, existing technology is utilized as needed. However, although said existing technology is for example existing LTE, it is not limited to the existing LTE. Also, unless otherwise described, the term “LTE” used herein has a broad meaning which encompasses LTE-Advanced and post LTE-Advanced schemes (for example, NR).

Also, in an embodiment of the present invention, a duplex scheme may be a TDD (Time Division Duplex) scheme, a FDD (Frequency Division Duplex) scheme, or another scheme (for example, Flexible Duplex, etc.). Also, in the explanation below, a method of transmitting a signal using a transmission beam may be a digital beam forming which transmits a signal multiplied with a precoding vector (pre-coded with a precoding vector), or an analog beam forming which realizes a beam forming using a variable phase shifter in a RF (Radio Frequency) circuit. Similarly, a method of receiving a signal using a received beam may be a digital beam forming which multiplies a predetermined weight vector to the received signal, or an analog beam forming which realizes a beam forming using a variable phase shifter within a RF circuit. A hybrid beam forming which combines a digital beam forming and an analog beam forming may also be applied. Also, transmitting a signal using a transmitted beam may be transmitting a signal at a certain antenna port. Similarly, receiving a signal using a received beam may also be receiving a signal at a certain antenna port. An antenna port refers to a logic antenna port or physical antenna port defined by 3GPP standard.

Meanwhile, a method of forming a transmitted beam and a received beam is not limited to the above-described method. For example, in a base station apparatus 10 or user apparatus 20 which is provided with a plurality of antennas, a method of changing angles of respective antennas may be used, a method of combining a method of using a pre-coding vector and a method of changing an angle of antenna may be used, different antenna panels may be switched and utilized, a method of combining a plurality of methods in which a plurality of antenna panels may also be joined and used, and other methods may be used. Also, for example, a plurality of transmitted beams which are different from each other may be used. An operation in which a plurality of transmitted beams are used is referred to as a multi-beam operation, and an operation in which one received beam is used is referred to as a single beam operation.

Also, in an embodiment of the present invention, an expression that radio parameters, etc. are “configured” may mean that a predetermined value is pre-configured or radio parameters notified from the base station apparatus 10 or user apparatus 20 are configured.

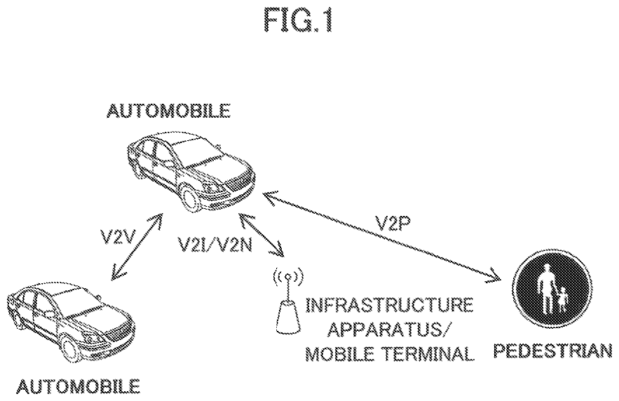

FIG. 1 is a diagram for explaining the V2X. In 3GPP, it is under consideration to expand D2D function to achieve V2X (Vehicle to Everything) or eV2X (enhanced V2X), and its standardization is under way. As shown in FIG. 1, V2X is a part of ITS (Intelligent Transport Systems) and a general term for V2V (Vehicle to Vehicle) meaning a communication form performed between vehicles, V2I (Vehicle to Infrastructure) meaning a communication form performed between a vehicle and a RSU (Road-Side Unit) installed at road side, V2N (Vehicle to Nomadic Device) meaning a communication form performed between a vehicle and a mobile terminal possessed by a driver, and V2P (Vehicle to Pedestrian) meaning a communication form performed between a vehicle and a mobile terminal possessed by a pedestrian.

In an embodiment of the present invention, a form in which a communication apparatus is mounted on a vehicle is contemplated, but an embodiment of the present invention is not limited to said form. For example, a communication apparatus may be a terminal possessed by a human, or it may be an apparatus which is mounted on a drone or an aircraft.

Also, in Rel-14 of LTE, a standardization relating to several functions of V2X is being made. In said standardization, Mode 3 and Mode 4 are regulated with respect to a resource allocation for V2X communication to a user apparatus. In Mode 3, a transmission resource is dynamically allocated by DCI (Downlink Control Information) transmitted from a base station apparatus 10 to a user apparatus 20. Also, in Mode 3, SPS (Semi Persistent Scheduling) is also possible. In Mode 4, a user apparatus 20 autonomously selects a transmission resource from a resource pool.

Also, in 3GPP, V2X using cellular communication or terminal-to-terminal communication of LTE or NR is under consideration. With respect to V2X of LTE or NR, it is contemplated that in the future, considerations which are not limited to 3GPP specification will be carried out. For example, it is contemplated that securing of interoperability, cost efficiency by implementation of an upper layer, combined use or switching method of a plurality of RATs (Radio Access Technologies), correspondence with the regulations in respective countries, and data acquisition and distribution of V2X platform of LET or NR, and database management and use method will be considered.

Here, as a requirement condition of eV2X, it is listed to respond to an event-trigger type traffic. The event-trigger type traffic is a typical traffic type in eV2X. The even-trigger type traffic, for example, requires a high data rate which is as high as several tens of Mbps. For example, a case where high-resolution video is transmitted from a user apparatus 20 to other user apparatus 20, a car where Raw sensor data are transmitted, a case where data assisting an automatic driving, etc. are transmitted, are contemplated.

In order to respond to the event-trigger type traffic, it is contemplated that a broad frequency band is utilized. However, occurrences of the event-trigger type traffic are few, in a case where a resource pool in a broad frequency band for the event-trigger type traffic is set, a waste of resources becomes larger. Therefore, the efficient use of frequency band is required while responding to the event-trigger type traffic.

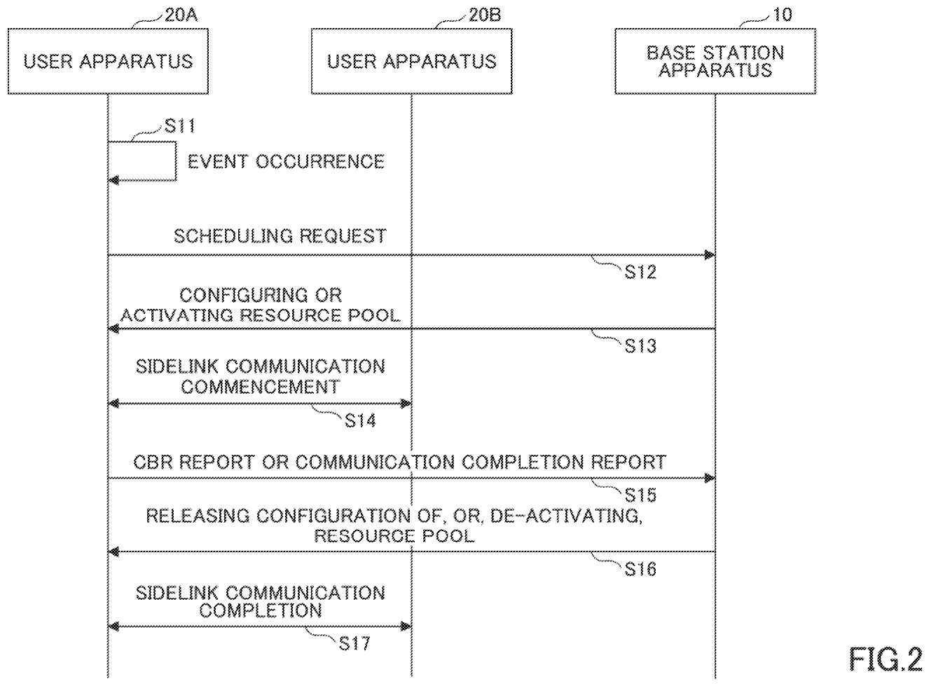

FIG. 2 is a sequence diagram for explaining a procedure of communication control in an embodiment of the present invention. In the procedure shown in FIG. 2, the user apparatus 20 performs D2D communication by an event-trigger type traffic. In order to respond to the event-trigger type traffic, an on-demand sidelink resource pool is introduced. That is, a resource pool is set each time an event-trigger type traffic occurs. Here, in order to devise a resource share of UL (Uplink) or DL (Downlink) and SL, a base station apparatus 10 or a specific user apparatus 20 manages the resource. In order to manage the resource, a method of allocating a transmission resource by Mode 3 of V2X in LTE may be used.

In Step 11, a user apparatus 20A detects an occurrence of an event. The event, for example, as described above, corresponds to a request for transmission of high-resolution video, Raw sensor data, and data for assisting an automatic driving, etc. At the user apparatus 20A, an event-trigger type traffic occurs by the occurrence of the event.

In Step 12, although the user apparatus 20A transmits a scheduling request (SR) for requesting the securement of an on-demand resource pool for transmitting event-trigger type data, to the base station apparatus 10. Subsequently, the base station apparatus 10 configures the on-demand resource pool based on the scheduling request received from the user apparatus 20A (S13). The on-demand resource pool is used for sidelink communication for the user apparatus 20A and a user apparatus 20B. The information showing the on-demand resource pool may be notified from the base station apparatus 10 to the user apparatus 20B in addition to the user apparatus A, or to the user apparatus A or B.

In the meantime, after the on-demand resource pool is configured, it may also be activated. That is, the base station unit 10 may configure the on-demand resource pool, and thereafter may activate it, or it may be automatically activated at the same time the on-demand resource pool is configured.

Also, FIG. 2 is an example in which the on-demand resource pool is managed by the base station apparatus 10, for example, an apparatus other than the base station apparatus (a UE/BS type RSU, a user apparatus, etc.) may manage the on-demand resource pool. That is, in FIG. 2, the base station apparatus 10 may be replaced with a user apparatus 20C or a RSU. The user apparatus 20C is an apparatus other than a base station apparatus, which performs UL and (or) DL transmission in a group to which the user apparatus 20A, the user apparatus 20B and the user apparatus 20C belong. Also, for example, the base station apparatus 10 may configure the on-demand resource pool, and thereafter an apparatus other than the base station apparatus may activate the on-demand resource pool.

In Step S14, the user apparatus 20A and user apparatus 20B use the on-demand resource pool configured at Step S13 to start sidelink communication. The event-trigger type data are transmitted from the user apparatus 20A to the user apparatus 20B by said sidelink communication.

In Step S15, the user apparatus 20A in sidelink communication may report CBR (Channel Busy Ratio) of the on-demand resource pool to the base station apparatus 10. In a case where the reported CBR is below a predetermined threshold value, the base station apparatus 10 may release the configuration of, or de-activate, the on-demand resource pool (S16). Information indicating the release of the configuration of, or the de-activation of, the on-demand resource pool may be notified from the base station apparatus 10 to the user apparatus 20A or the user apparatus 20B.

Also, in Step S15, the user apparatus 20A in sidelink communication may report to the base station apparatus 10 that the user apparatus 20A ends communication relating to the on-demand resource pool. In a case where the base station apparatus 10 receives a report that the communication ended, it de-configures or de-activates the on-demand resource pool (S16). Information indicating the de-configuration or the de-activation may be notified from the base station apparatus 10 to the user apparatus 20A or the user apparatus 20B.

Note that the de-configuration or de-activation of the on-demand resource spool by the base station apparatus 10 in Step S15 may be determined by the base station apparatus 10 regardless of the report from the user apparatus 20.

Note that the de-configuration or the de-activation of the on-demand resource spool by the base station apparatus 10 in Step S15 may be performed by an apparatus other than the base station apparatus.

In Step S17, the user apparatus 20A and the user apparatus 20B end the sidelink communication using the on-demand resource pool.

Note that a user apparatus 20 located outside the coverage of the base station apparatus 10 may use a pre-configured on-demand resource pool, or may use an on-demand resource pool which is configured with RRC signaling or reported information, etc. while in the coverage. Also, a user apparatus 20 located outside the coverage of the base station apparatus 10 may not be permitted the use of the on-demand resource pool.

Note that the base station apparatus 10 may notify a user apparatus 20 of the configuration, de-configuration, activation or de-activation via any of a signaling of a PHY (Physical) layer signaling, a MAC (Medium Access Control) layer signaling (for example, MC, CE (Control Element)), or a RRC (Radio Resource Control) layer signaling. Also, the on-demand resource pool may be regulated by a resource specifying a frequency domain or time domain, may be regulated by a resource set, may be regulated by a frequency band, may be regulated by a band, or may be regulated by a carrier.

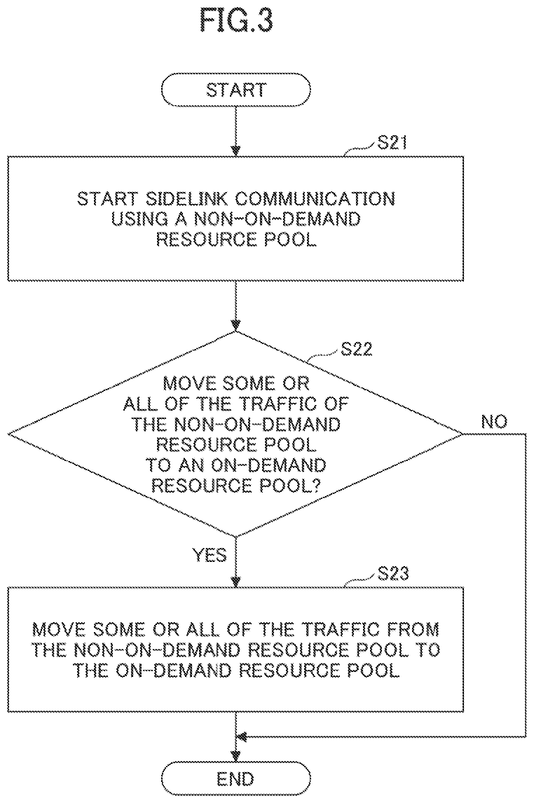

FIG. 3 is a flow chart explaining a procedure of communication control in an embodiment of the present invention. The user apparatus 20 may also communicate some or all of sidelink communication traffic which used a non-on-demand resource pool using an on-demand resource pool. Note that, as in FIG. 2, the user apparatus 20A and the user apparatus 20B which perform sidelink communication using an on-demand resource pool belong to the same group, and the user apparatus 20A may be an apparatus other than a base station apparatus which performs UL and (or) DL transmission. The resource allocation of said traffic may be performed based on an instruction of the base station apparatus 10, or may be performed based on the implementation of the user apparatus 20.

In Step S21, the user apparatus 20A starts sidelink communication using a non-on-demand resource pool with the user apparatus 20B.

In Step S22, the user apparatus 20A determines whether to transfer some or all of the traffic from a non-on-demand resource pool to an on-demand resource pool based on the instructions of the base station apparatus 10 or a pre-regulated implementation. In a case where it is transferred (Yes of S22), the flow proceeds to Step S23, and in a case where it is not transferred (No of S22), the flow ends. In a case where it is not transferred (No of S22), only on-demand data will be transmitted in the on-demand resource pool.

In Step S23, the user apparatus 20A transfers some or all of the traffic to the user apparatus 20B from the non-on-demand resource pool to the on-demand resource pool.

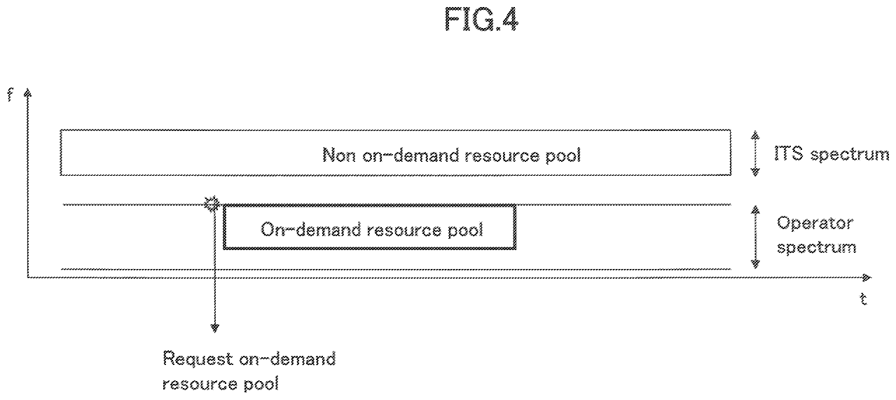

FIG. 4 is a diagram showing an example of a resource pool in an embodiment of the present invention. In FIG. 4, a non-on-demand resource pool is configured in an ITS frequency band, and an on-demand resource pool is configured in a frequency band in which a license is granted to a telecommunication carrier.

As shown in FIG. 4, after a request for an on-demand resource pool has occurred, the on-demand resource pool is secured. The transfer of traffic in Step S23 of FIG. 3 is performed by some or all of the traffic being changed from the non-on-demand resource pool to the on-demand resource pool.

Some or all of the frequency bands in which the on-demand resource pool and the non-on-demand resource pool are respectively located may overlap each other. For example, in the overlapped frequency bands, a traffic in which a priority of PPPP (ProSe Per Packet Priority), etc. is high may be given a priority. Also, a resource which is not overlapping with the non-on-demand resource pool, in the on-demand resource pools, may be used as a non-on-demand resource pool in accordance with the priority of PPPP, etc. For example, in a case where traffic relating to a non-on-demand resource pool is of higher priority than a traffic relating to an on-demand resource pool, a resource which is not overlapping with the non-on-demand resource pool, in the on-demand resource pool, may be used as a non-on-demand resource pool.

Note that, in a case where an on-demand resource pool is configured in DL or SL frequency band, UL transmission, DL reception or SL transmission and reception being performed in said on-demand resource pool is stopped as described in 1), 2) and 3) below.

1) The base station apparatus 10 or the RSU, etc. reschedules another resource to a user apparatus 20 which is performing UL transmission, DL reception, or SL transmission and reception in an on-demand resource pool. A resource in the originally scheduled on-demand resource pool is dropped. When implicitly notified, a user apparatus 20 drops a resource in the originally scheduled on-demand resource pool by other resources being scheduled. When explicitly notified, a user apparatus 20 is notified from the base station apparatus 10 or the RSU, etc., by a signaling of PHY layer or higher layer, for example, by DCI (Downlink Control Information) for re-scheduling, a MAC signaling or a RRC signaling.

2) The base station apparatus 10 or the RSU, etc. instructs the user apparatus 20 which is transmitting and receiving a UL, DL or SL in the on-demand resource pool to discard transmitted and received packets, by a signaling of PHY layer or higher layer, for example, control information by a MAC, CE, RRC signaling. The user apparatus 20 drops the transmission and reception upon the detection of an ID associated with the notice of said control information, or drops the transmission and reception upon detecting that the notice of said control information corresponds to a resource which is allocated to itself.

3) The configuration for the on-demand resource pool is broadcasted to a user apparatus 20 within the coverage, for example, as system information including information for identifying the user apparatus 20 or information for identifying a resource. The user apparatus 20 drops the transmission performed in said on-demand resource pool. The operation of the user apparatus 20 may also be pre-defined or pre-configured.

Also, the user apparatus 20 may transmit the non-on-demand data with the on-demand data when performing transmission using the on-demand resource pool.

Also, when the on-demand resource pool is configured in a frequency band of a UL, DL or SL as an implementation of the network, a cell-specific or UE (User Equipment)-specific configuration relating to the transmission and reception as well as monitoring in a frequency band of said UL, DL or SL may be re-configured.

For example, a re-configuration is performed in a case where the following one or more channels are overlapped with the on-demand resource pool:

1) PBCH

2) A part of PDCCH or PUCCH (for example, a control resource set for a paging opportunity)

3) A part of PDSCH or PUSCH (for example, PDSCH for transmitting system information)

4) PRACH

5) SRS resource

The user apparatus 20 performing UL transmission, DL reception or SL transmission and reception re-configures a control resource set which it monitors in a case where an on-demand resource pool is configured in a frequency band of a UL, DL or SL. For example, the user apparatus 20 reconfigures a control signal to be monitored. Also, the user apparatus 20 may stop a monitoring with respect to a resource which is overlapped with the on-demand resource pool.

Note that, signals in a different configuration may be used in the on-demand resource pool and the non-on-demand resource pool. For example, DFT-S-OFDM (Discrete Fourier Transform Spread Orthogonal Frequency Division Multiplexing) and CP-OFDM (Cyclic-Prefix Orthogonal Frequency Division Multiplexing) may be used, a different numerology (for example, sub-carrier interval and symbol length) may be used, or a different BWP (Bandwidth Part) may be used. In the meantime, signals used in the on-demand resource pool and the non-on-demand resource pool may be defined by a specification, or configured by a DCI via PBCH, PSBCH, PDCCH or PDSCH, a SCI (Sidelink Control Information) via PSCCH or PSSCH, a MAC signaling, or a PRC signaling.

Also, a configuration relating to the on-demand resource pool may have the following. As a precondition, it is based on a resource pool in V2X of LTE Release 14. That is, in said configuration, a resource of time domain is notified by a bit map, and a start point and length of the frequency domain are notified.

1) A start point of the time domain of the on-demand resource pool may also be configured. For example, there may be provided, as an absolute value, a configuration, such as a system frame number (SFN), a direct frame number (DFN), a subframe number, etc. Or, there may be provided, as a relative value being a time shift, for example, information indicating a time period from a signaling in which an on-demand resource pool is configured to start.

2) There may be provided a configuration in which a channel or signaling of other PHY layers is eliminated from an on-demand resource pool. For example, it may be a configuration in which one or more following channels or signals are eliminated from an on-demand resource pool:

a) PBCH

b) A part of PDCCH or PUCCH (for example, a control resource set for a paging opportunity)

c) A part of PDSCH or PUSCH (for example, PDSCH for transmitting system information)

d) PRACH

e) SRS resource

Also, by configuration, at a certain resource pool, between UL and SL, between DL and SL, or between UL and DL and SL, a resource may also be shared. A timing alignment with a UL or DL and SL needs to be maximally assured in a resource pool for which a resource share is configured. Thus, one or more of the following options may also be performed.

1) A timing alignment which makes the base station apparatus 10 a reference is configured as a resource pool for which a resource share is configured.

2) A synchronization of a SL synchronization resource set may make the base station apparatus a reference, or a user apparatus 20 a reference, or a GNSS (Global Navigation Satellite System) a reference.

3) A case where the user apparatus 20 is made as a reference may be limited to a case where the user apparatus 20 is in the coverage of the base station apparatus 10.

Note that, in a case where a UL and SL shares a resource, a timing alignment may also be applied to SL transmission.

With the above-described embodiment, in a case where an event-trigger type traffic occurs, the user apparatus 20 can perform sidelink communication using an on-demand resource pool by requesting a configuration of an on-demand resource pool to the base station apparatus 10. Also, the user apparatus 20 can communicate in an efficient manner by a UL or DL and SL sharing a resource in the resource pool.

That is, a resource which a communication terminal requires in terminal-to-terminal direct communication can be allocated in an efficient manner.

(Apparatus Structure)

Next, an example of functional structure of the base station apparatus 10 and the user apparatus 20 which perform the above-explained process and operation will be explained. The base station apparatus 10 and the user apparatus 20 include functions to perform the above-described examples. However, the base station apparatus 10 and the user apparatus 20 each may also be provided with some of the functions in the examples.

<Base Station Apparatus>

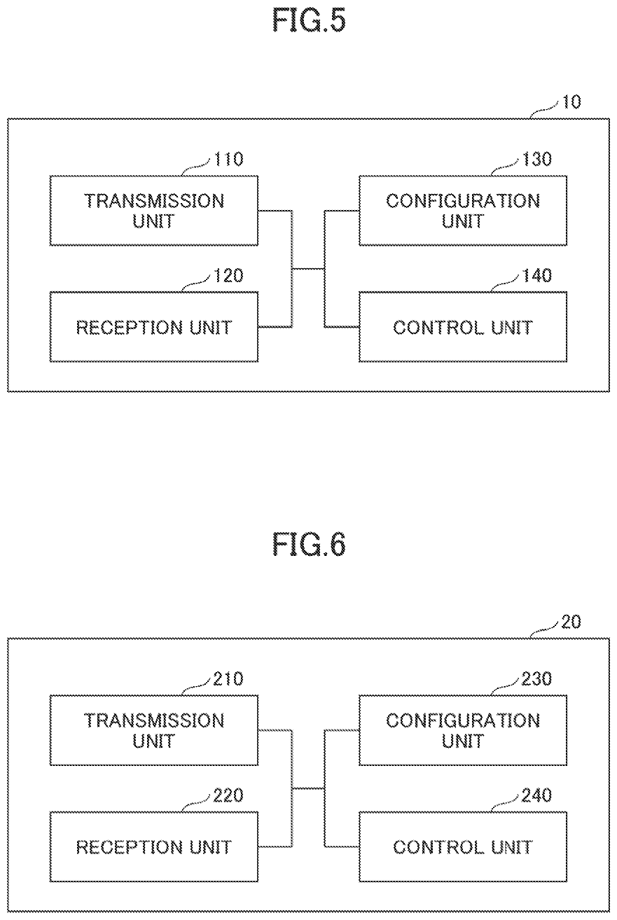

FIG. 5 is a diagram showing an example of a functional structure of the base station apparatus 10. As shown in FIG. 6, the base station apparatus 10 has a transmission unit 110, a reception unit 120, configuration unit 130, and a control unit 140. A functional structure shown in FIG. 5 is just an example. Any distinction between functions and name of function unit may be used as long as functions relating to the embodiments of the present invention can be performed.

The transmission unit 110 includes a function of generating a signal transmitted to a user apparatus 20 side and transmitting said signal wirelessly. The reception unit 120 includes a function of receiving a variety of signals transmitted from the user apparatus 20 and acquiring, for example, information of the upper layer from the received signals. Also, the transmission unit 110 has a function of transmitting a NR-PSS, NR-SSS, NR-PBCH, DL/UL control signal, etc. to the user apparatus 20. Also, for example, the reception unit 110 transmits information which indicates other terminal is approaching the user apparatus 20, and the reception unit 120 receives terminal information from the user apparatus 20.

The configuration unit 130 stores a pre-configured configuration information and a variety of configuration information transmitted to the user apparatus 20, and reads out from a storage apparatus as needed. The content of the configuration information is, for example, information relating to transmission and reception parameters of D2D communication, etc.

The control unit 140, as explained in the examples, autonomously or in accordance with the information notified by the user apparatus 20, performs a process of configuring, de-configuring, activating, or de-activating a resource pool used for D2D communication. Also, the control unit 140 performs a process of notifying the user apparatus 20 of the information relating to a configuration of radio communication. A function unit concerning signal transmission in the control unit 140 may be included in the transmission unit 110, and a function unit concerning signal reception in the control unit 140 may be included in the reception unit 120.

<User Apparatus 20>

FIG. 6 is a diagram showing an example of a functional structure of the user apparatus 20. As shown in FIG. 6, the user apparatus 20 has a transmission unit 210, a reception unit 220, a configuration unit 230, and a control unit 240. The functional structure shown in FIG. 6 is just an example. Any distinction between functions and name of the function unit may be used as long as the operations relating to the embodiments of the present invention can be performed.

The transmission unit 210 generates transmission signal from transmission data, and wirelessly transmits said transmission signal. The reception unit 220 wirelessly receives a variety of signals, and acquires an upper layer signal from a received physical layer signal. Also, the reception unit 220 has a function of receiving NR-PSS, NR-SSS, NR-PBCH, DL/UL/SL control signal, etc. transmitted from the base station apparatus 10. Also, for example, the transmission unit 210, as D2D communication, transmits PSCCH (Physical Sidelink Control Channel), PSSCH (Physical Sidelink Shared Channel), PSDCH (Physical Sidelink Discovery Channel), PSBCH (Physical Sidelink Broadcast Channel), etc. to other user apparatus 20, and the reception unit 220 receives PSCCH, PSSCH, PSDCH or PSBCH, etc. from other user apparatus 20.

The configuration unit 230 stores a variety of configuration information which the reception unit 220 received from the base station apparatus 10 or the user apparatus 20, reads our from a storage apparatus as needed. Also, the configuration unit 230 stores pre-configured configuration information as well. The content of the configuration information is, for example, information relating to transmission and reception parameters of D2D communication, etc.

The control unit 240, as explained in the examples, controls D2D communication performed with other user apparatus 20. Also, the control unit 240 receives information relating to radio communication from the base station apparatus 10, controls the radio communication of the user apparatus 20 in accordance with said information, and reports necessary information to the base station apparatus 10. A function unit concerning signal transmission in the control unit 240 may be included in the transmission unit 210, and a function unit concerning signal reception in the control unit 240 may be included in the reception unit 220.

(Hardware Structure)

The function structure figures (FIGS. 5 and 6) used for the explanation of the above-described embodiments of the present invention indicates bocks in the units of functions. These functional blocks (structure units) are realized by any combination of hardware and/or software. Also, means for realizing respective functional bocks are not particularly limited. That is, respective functional blocks may be realize by one apparatus in which a plurality of elements are physically and/or logically coupled together, or may be realized by directly and/or indirectly (for example, in a wired and/or wireless manner) connecting two or more physically and/or logically separated apparatuses.

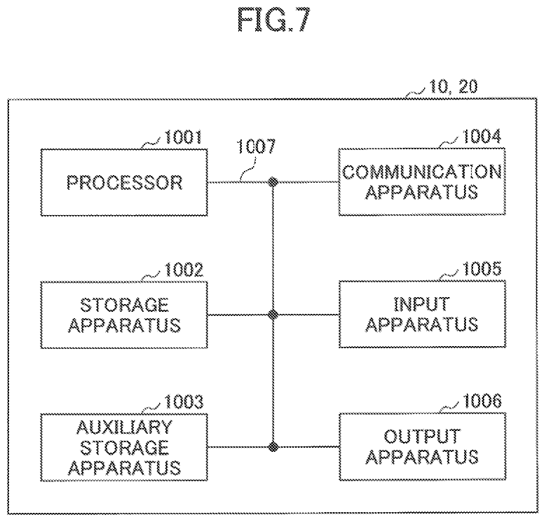

Also, for example, either of the base station apparatus 10 or the user apparatus 20 in one embodiment of the present invention may function as a computer for performing a process relating to the embodiments of the present invention. FIG. 7 is a diagram showing an example of hardware structure of a radio communication apparatus that is a base station apparatus 10 or a user apparatus 20 relating to the embodiments of the present invention. Physically, the above-described base station apparatus 10 and the user apparatus 20 may each be constructed as a computer apparatus including a processor 1001, a storage apparatus 1002, auxiliary storage apparatus 1003, a communication apparatus 1004, an input apparatus 1005, an output apparatus 1006, a bus 1007, etc.

In the meantime, in the explanation below, the term “apparatus” can be referred to as a circuit, device, unit, etc. A hardware structure of the base station apparatus 10 and the user apparatus 20 may be arranged to include one or more of the respective apparatuses designated with 1001-1006 shown in the figure, or arranged not to include some of the apparatuses.

Each function of the base station apparatus 10 and the user apparatus 20 is realized by a processor 1001 performing computations by reading certain software (programs) on hardware, such as a processor 1001, a storage apparatus 1002, etc., and by controlling communication by communication apparatus 1004, and reading-out and/or writing-in of data in the storage apparatus 1002 and auxiliary storage apparatus 1003.

The processor 1001, for example, causes an operating system to run to control a whole of the computer. The processor 1001 may be comprised of a central processing unit (CPU) including an interface with peripherals, a control apparatus, a computation apparatus, a register, etc.

Also, the processor 1001 reads out a program (program code), a software module or data from the auxiliary storage apparatus 1003 and/or the communication apparatus 1004 to the storage apparatus 1002, and performs each of a variety of processes according to these. As for a program, a program for causing a computer to perform at least some of the operations explained in the above-described embodiments is used. For example, the transmission unit 110, the reception unit 120, the configuration unit 130, and the control unit 140 of the base station apparatus 10 shown in FIG. 5 may be stored in the storage apparatus 1002, and realized by a control program running on the processor 1001. Also, for example, the transmission unit 210, the reception unit 220, the configuration unit 230, and the control unit 240 of the user apparatus 20 shown in FIG. 6 may be stored in the storage apparatus 1002, and realized by a control program running on the processor 1001. Although each of the above-described variety of processes was explained to be performed by one processor 1001, they may also be performed concurrently or sequentially by two or more processors 1001. The processor 1001 may be implemented in one or more chips. In the meantime, the program may also be transmitted from a network via an electric communication line.

The storage apparatus 1002 is a computer readable recording medium, and may be comprised of at least one of ROM (Read Only Memory), EPROM (Erasable Programmable ROM), EEPROM (Electrically Erasable Programmable ROM), RAM (Random Access Memory), etc. The storage apparatus 1002 may also be referred to as a register, cash, main memory, etc. The storage apparatus 1002 can save a program (program code), a software module, etc., which is executable to implement a process relating to one embodiment of the present invention.

The auxiliary storage apparatus 1003 is a computer readable recording medium, and may be comprised of at least one of an optical disk such as CD-ROM (Compact Disc ROM), hard disk drive, flexible disk, magneto-optical disk (for example, a compact disk, digital versatile disk, Blue-Ray (registered trademark) disk, smart card, flash memory (for example, card, stick, key drive), floppy (registered trademark) disk, magnetic strip, etc. The auxiliary storage apparatus 1003 may be referred to as an auxiliary memory apparatus. The above-described may also be, for example, database including a storage apparatus 1002 and/or an auxiliary storage apparatus 1003, a server, or other suitable medium.

The communication apparatus 1004 is a hardware (transmission and reception device) for performing communication between computers via a wired and/or wireless network, and for example is referred to as network device, a network controller, a network card, a communication module, etc. For example, the transmission unit 110 and the reception unit 120 of the base station apparatus 10 may be realized by a communication apparatus 1004. Also, the transmission unit 210 and the reception unit 220 may be realized by a communication apparatus 1004.

The input apparatus 1005 is an input apparatus (for example, a key board, mouse, microphone, switch, button, sensor, etc.) which receives an input from outside. The output apparatus 1006 is an output apparatus (for example, a display, speaker, LED lamp, etc.) which implements an output to the outside. In the meantime, the input apparatus 1005 and the output apparatus 1006 may also be an integrated structure (for example, a touch panel).

Also, respective apparatuses, such as a processor 1001 and a storage apparatus 1002 are connected by a bus 1007 for transmitting information. The bus 1007 may be formed by a single bus, or by different buses between the apparatuses.

Also, each of the base station apparatus 10 and the user apparatus 20 may be formed to include hardware, such as a microprocessor, digital signal processor (DSP), ASIC (Application Specific Integrated Circuit), PLD (Programmable Logic Device), FPGA (Field Programmable Gate Array), etc., and some or all of respective functional blocks may also be realized by said hardware. For example, the processor 1001 is implemented in at least one of hardware.

### Summary of Embodiments

As explained above, in accordance with the embodiments of the present invention, there is provided a user apparatus, which comprises a request unit for transmitting a scheduling request to a base station apparatus, an acquisition unit for receiving information indicative of a resource pool based on said scheduling request from the base station, and a communication unit for performing sidelink transmission to another user apparatus using said resource pool.

With the above-described structure, in a case where an event-trigger type traffic occurs, the user apparatus 20 can use an on-demand resource pool to perform sidelink communication by requesting a configuration of the on-demand resource pool to the base station apparatus 10. That is, a resource which a communication terminal requires in terminal-to-terminal direct communication can be allocated in an efficient manner.

The above-described communication unit may perform uplink transmission to the base station apparatus by using the resource pool, or may perform downlink reception from the base station apparatus by using the resource pool. With said structure, the user apparatus 20 can perform communication, in which use efficiency of the resource is high by UL or DL and SL sharing a resource in the resource pool.

The above-described request unit may report a CBR (Channel Busy Ratio) of the above-described resource pool to the above-described base station apparatus, the above-described acquisition unit may receive an instruction based on the CBR of the above-described resource pool from the above-described base station apparatus, and the above-described communication unit may stop communication using the above-described resource pool, based on the instruction. With said structure, the user apparatus 20 can perform communication in which use efficiency of the resource is high by stopping communication by the resource pool in a case where the CBR of the resource pool is low.

In a case where uplink transmission, downlink reception or sidelink transmission and reception has been already performed at the resource pool and a resource is newly scheduled from the base station apparatus as of the time of receiving the information indicative of the resource pool based on the scheduling request from the base station apparatus, a resource which was being used for uplink transmission, downlink reception or sidelink transmission and reception at the resource pool may be dropped. With said structure, in a case where the user apparatus 20 was performing UL transmission or DL reception in the secured resource pool, it can stop said transmission and reception, and use another resource to perform UL transmission or DL reception.

In a case where the resource pool based on the scheduling request is overlapped with another resource pool, a resource which is not overlapped with the other resource pool, in the resource pool based on the scheduling request, may be used as the other resource pool when traffic of the other resource pool is higher in priority than traffic of the resource pool based on the scheduling request. Said structure allows other traffic of a higher priority to use a resource secured as an on-demand resource pool.

Also, in accordance with the embodiment of the present invention, there is provided a base station apparatus, which has a process unit configured to receiver a scheduling request from a user apparatus, an instruction unit configured to transmit information indicative of a resource pool based on the scheduling request to the user apparatus, and a communication unit configured to perform uplink reception from the user apparatus by using the resource pool and for performing downlink transmission to the user apparatus by using the resource pool.

With the above-described structure, in a case where an event-trigger type traffic occurs in the user apparatus 20, the base station apparatus 10 can cause the user apparatus 20 to use the on-demand resource pool to perform sidelink communication by configuring the on-demand resource pool to notify the user apparatus 20. That is, it is possible to efficiently allocate a resource which a communication terminal requires in terminal-to-terminal direct communication.

### Supplementary Embodiments

In the foregoing, while the embodiments of the present invention have been explained, a disclosed invention is not limited to such embodiments, those skilled in the art will appreciate a variety of variations, modifications, alternatives, substitutions, etc. While the explanation was made using specific examples of numerical values so as to facilitate the understanding of the invention, unless otherwise indicated, those numerical values are mere examples, and any suitable value may be used. A distinction between the items in the above-described explanations are not essential to the present invention, and matters described in two or more items may be used in combination as needed, or a certain matter described in a certain items may be applied to a matter described in other items (as long as there is conflict). A border between the function units or process unit in the functional block diagram does not necessarily correspond to a border between the physical units. Physically, the operation of a plurality of function unit may be performed by one unit, or the operation of one function unit may be performed by a plurality of units. With respect to the procedure described in the embodiments, the order of the process may be switched as long as there is no contradiction. For the sake of the convenience of explanation, the base station apparatus 10 and the user apparatus 20 have been explained using a functional block diagram, such apparatuses may be embodied by hardware, software, or a combination of both. Software which is run by a processor comprised in the base station 10 in accordance with the embodiments of the present invention and software which is run by a processer comprised in the user apparatus 20 in accordance with the embodiments of the present invention may each be saved in a random access memory (RAM), flash memory, read only memory (ROM), EPROM, EEPROM, register, hard disk (HDD), removable disk, CD-ROM, database, server, or any other suitable storage medium.

Also, the notification of information is not limited to the aspect/embodiment explained herein, and it may be performed by other method. For example, the notification of information may be performed by a physical layer signaling (for example, DCI (Downlink Control Information), UCI (Uplink Control Information)), upper layer signaling (for example, RRC (Radio Resource Control) signaling, MAC (Medium Access Control) signaling, broadcast information (MIB (Master Information Block), SIB (System Information Block)), other signals, or a combination of these. Also, the RRC signaling may be referred to as RRC message, for example, it may be a RRC Connection Setup message, RRC Connection Reconfiguration message, etc.

Respective aspects/embodiments explained herein may be applied to LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), system utilizing other suitable system, and/or next generation system expanded based upon these.

The order of the procedure, sequence, flow chart, etc. of respective aspects/embodiments explained herein may be switched as long as there is no contradiction. For example, with respect to the methods explained herein, elements of a variety of Steps are presented in the exemplary order, they are not restricted to the presented order.

In some cases, specific operation which is described as being performed by a base station apparatus 10 herein may be performed by its upper node. In a network comprised of one or more network nodes having a base station apparatus 10, it is obvious that the operation performed for communication with a user apparatus 20 can be performed by other network other than a base station apparatus 10 or a user apparatus 20 (for example, MME or S-GW etc. is contemplated, but not limited thereto). In the foregoing, a case where other network node other than a base station apparatus 10 is one, there may be a combination of a plurality of other network nodes (for example, MME and S-GW).

Each aspect/embodiment explained herein may be used alone or in combination, or it may be switched as it is performed.

The user apparatus 20 may also be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several other suitable terms by those skilled in the art.

The base station apparatus 10 may also be referred to as a NB (NodeB), an eNB (evolved NodeB), a gNB, a base station, or several other suitable terms by those skilled in the art.

The term “determining” or “deciding” used herein may encompass a wide variety of operations. The terms “determining” or “deciding” may include, for example, deeming that to perform judging, calculating, computing, processing, deriving, investigation, looking up (for example, looking up in a table, database or other data structure), or ascertaining is to performing “determining” or “deciding.” Also, “determining” or “deciding” may also include deeming that to perform receiving (for example, receiving information), transmitting (for example, transmitting information), inputting, outputting, or accessing (for example, accessing data in a memory) is to perform “determining” or “deciding.” Also, the terms “determining” or “deciding” may also include deeming that to perform resolving, selecting, choosing, establishing, or comparing is to perform “determining” or “deciding.” Namely, “determining” or “deciding” may include deeming that to perform “determining” or “deciding” is to perform “determining” or “deciding” some sort of operation.

The description of “based on” used herein does not mean “only based on” unless otherwise explicitly described. In other words, the description of “based on” means both of “only based on” and “at least based on.”

So long as the terms “include,” “including” and variations thereof are used herein or in the appended claims, these terms are intended to be inclusive as with the term “comprising.” Further, the term “or” used herein or in the appended claims is intended not to mean exclusive or.

In the entirety of the present disclosure, for example, in a case where articles, such as a, an, and the, are added by translation, these articles may include the plural unless otherwise indicated from a context.

In the meantime, in the embodiments of the present invention, a control unit 240 is an example of a request unit or an acquisition unit. A transmission unit 210 or a reception unit 220 is an example of a communication unit. A control unit 140 is an example of a process unit or an instruction unit. A transmission unit 110 or a reception unit 120 is an example of a communication unit.

In the foregoing, although the present invention is described in detail, it is obvious to those skilled in the art that the present invention is not limited to the embodiments described herein. The present invention can be implemented as modifications and variations without departing from the gist and scope of the present invention defined in the descriptions of claims. Therefore, the description of the present specification is intended to be exemplary, and does not have any restrictive meaning to the present invention.

### LIST OF REFERENCE SYMBOLS

10 base station apparatus

110 transmission unit

120 reception unit

130 configuration unit

140 control unit

20 user apparatus

210 transmission unit

220 reception unit

230 configuration unit

240 control unit

1001 processor

1002 storage apparatus

1003 auxiliary storage apparatus

1004 communication apparatus

1005 input apparatus

1006 output apparatus

1. A user apparatus comprising:
a request unit configured to transmit a scheduling request to a base station apparatus;
an acquisition unit configured to receive information indicative of a resource pool based on the scheduling request from the base station apparatus; and
a communication unit configured to perform sidelink transmission to another user apparatus using the resource pool.

2. The user apparatus according to claim 1, wherein the communication unit performs uplink transmission to the base station apparatus using the resource pool and performs downlink reception from the base station apparatus using the resource pool.

3. The user apparatus according to claim 1, wherein the request unit reports a CBR (Channel Busy Ratio) of the resource pool to the base station apparatus, wherein the acquisition unit receives an instruction based on the CBR of the resource pool from the base station apparatus, and
wherein the communication unit, based on the instruction, stops communication using the resource pool.

4. The user apparatus according to claim 1, wherein in a case where, as of the time of receiving the information indicative of the resource pool based on the scheduling request from the base station apparatus, uplink transmission, downlink reception, or sidelink transmission and reception has been already performed with the resource pool, and where a resource has been newly scheduled from the base station apparatus, a resource which was being used for the uplink transmission, the downlink reception, or the sidelink transmission and reception with the resource pool is dropped.

5. The user apparatus according to claim 1, in a case where the resource pool based on the scheduling request overlaps with another resource pool,
a resource which is not overlapping with said another resource pool, in the resource pool based on the scheduling request, is used as said another resource pool, when a traffic of said another resource pool is higher in priority than traffic of the resource pool based on the scheduling request.

6. A base station apparatus comprising:
a process unit configured to receive a scheduling request from a user apparatus;
an instruction unit configured to transmit information indicative of a resource pool based on the scheduling request; and
a communication unit configured to perform uplink reception from the user apparatus using the resource pool and to perform downlink transmission to the user apparatus using the resource pool.
